(19) United States
(12) Patent Application Publication
(10) Pub. No.: US 2015/0131835 A1
(43) Pub. Date: May 14, 2015

(54) EASY ASSEMBLED AND DETACHED TOUCH PEN WITH SOUND EMISSION PATHS

(71) Applicant: KUO-SHIH HUANG, Taipei Hsien (TW)

(72) Inventor: KUO-SHIH HUANG, Taipei Hsien (TW)

(21) Appl. No.: 14/077,155

(22) Filed: Nov. 11, 2013

(51) Int. Cl. H04R 1/02; G06F 3/0354; H04R 1/32

(52) U.S. Cl. CPC H04R 1/028; H04R 1/323; G06F 3/03545; H04R 2499/11
USPC 381/338

(57) ABSTRACT

An easy assembled and detached touch includes a pen body having a hollow portion, a touch end, a first opening, a second opening; the hollow portion having an oblong shape and penetrating through a front and a rear side thereof; the first opening and second opening is opened at an upper side of the pen body and is communicated to the hollow portion; the touch end having a conductive head; a sound guiding unit being a protrusion having a size approximately matched to that of the hollow portion; a sound path for guiding sound from one end to another end of the sound guiding unit; in assembly state; the sound path having one end coupled to an electronic device; and an inserting unit formed at the lateral side of the sound guiding unit which can be inserted into an insertion hole at a lateral side of the audio device.

### FIELD OF THE INVENTION

The present invention relates to touch pens, in particular to an easy assembled and detached touch pen with sound emission paths.

### BACKGROUND OF THE INVENTION

Currently, since touch panes are widely used in various electronic devices so that users often carry touch pens in bodies. The touch pen is stored generally in a pocket, a wallet, a bag, etc. In use of the touch pen, the user takes out the pen thereform. However, this action is inconvenient and it is often that the user must take time to find the pen, even the pen is lost and thus cannot be found. All these causes inconvenience in use of the touch pens.

Generally, a portable electronic device has some holes for sound emission or insertion of power wires, etc. Generally, sound emitted from the sound hole will disperse disorderly and thus cannot be concentrated to the ears of the user so that the sound quality is not good.

Therefore, there is an eager demand for a novel device which can resolve problems in one application.

### SUMMARY OF THE INVENTION

Accordingly, the object of the present invention is to provide an easy assembled and detached touch pen with sound emission paths, wherein the present invention provides an easily assembled and detachable touch pen structure which can be attached to the portable device easily and conveniently so that the user needs not to carry the pen further. Moreover, the touch pen of the present invention provides a well sound emission path, causing not shielding to the sound emitted from the portable electronic device.

To achieve above object, the present invention provides an easy assembled and detached touch pen with sound emission paths comprising: a pen body having a hollow portion, a touch end, a first opening, a second opening; the hollow portion having an oblong shape and penetrating through a front and a rear side of the pen body; the first opening and second opening is opened at an upper side of the pen body and is communicated to the hollow portion; the touch end having a conductive head; a sound guiding unit being a protrusion having an approximate oblong shape and having a size approximately matched to that of the hollow portion of the pen body so that the sound guiding unit can be embedded into the hollow portion; a sound path for guiding sound from one end to another end of the sound guiding unit; in assembly state; the sound path has one end coupled to the sound emitting hole of a portable electronic device; and another end of the sound path is opened so that sound from the electronic device is transmitted out from sound path; and an inserting unit formed at the lateral side of the sound guiding unit which can be inserted into an insertion hole at a lateral side of the audio device.

In the present invention, the sound path of the sound guiding unit is formed that: at a left end of the upper side of the sound guiding unit has a first upper sound guide hole and a left end of a lateral side of the sound guiding unit has a first lateral sound guide hole which is communicated to the first upper sound guide hole; at a right end of the upper side of the sound guiding unit has a second upper sound guide hole and a right end of a lateral side of the sound guiding unit has a second lateral sound guide hole which is communicated to the second upper sound guide hole; and wherein in assembly state, the sound guiding unit is embedded into the pen body; and then the pen body is installed to an electronic device by inserting into an insertion hole of the electronic device, in that the first lateral sound guide hole and the second lateral sound guide hole are corresponding to the sound output ends of the audio device; and the first upper sound guide hole and the second upper sound guide hole are corresponding to the first opening an the second opening of the pen body so that sound from the audio device is emitted to the first lateral sound guide hole and the second lateral sound guide hole and then are transmitted to the first opening and the second opening; and then are transmitted out.

The various objects and advantages of the present invention will be more readily understood from the following detailed description when read in conjunction with the appended drawing.

### BRIEF DESCRIPTION OF THE DRAWINGS

FIG. 1 is an exploded view showing the structure of the first embodiment of the present invention.

FIG. 2 is a partial schematic view of the first embodiment shown in FIG. 1.

FIG. 3 is an assembled view about the first embodiment of the present invention.

FIG. 4 shows the application about the first embodiment of the present invention.

FIG. 5 is an exploded view about the second embodiment of the present invention.

FIG. 6 is a partial schematic view about the second embodiment of the present invention.

FIG. 7 is an assembled view about the second embodiment of the present invention.

FIG. 8 is the assembled view about the third embodiment of the present invention.

FIG. 9 shows the application about the third embodiment of the present invention.

FIG. 10 is an exploded view about the third embodiment of the present invention.

FIG. 11 is an assembled view about the third embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

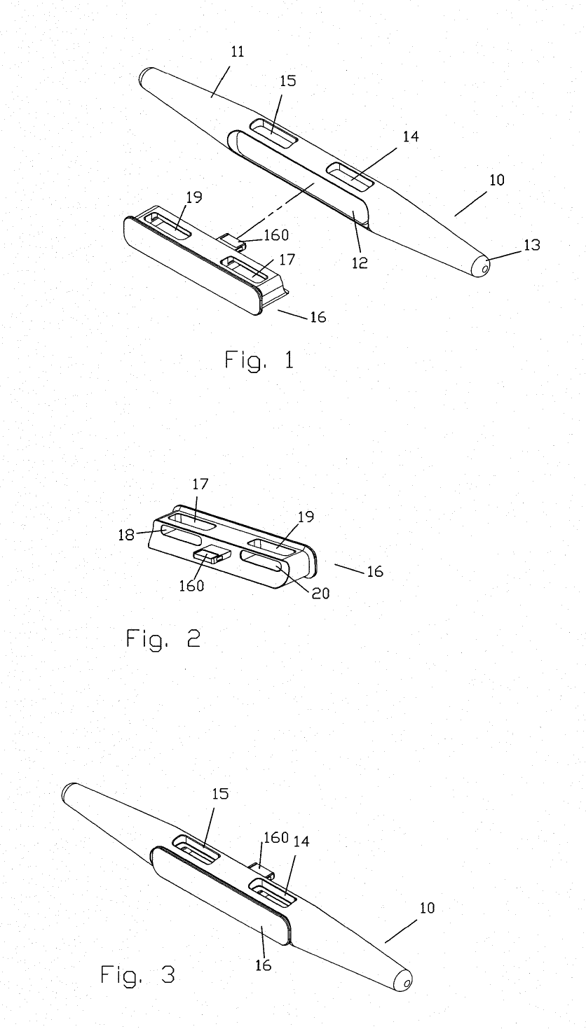

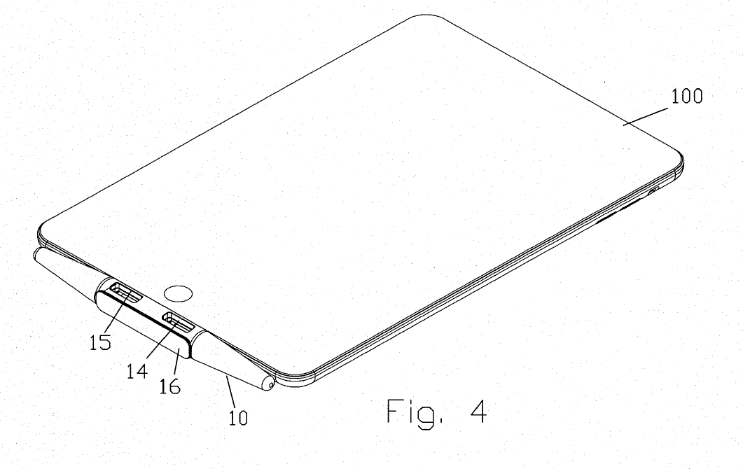

With reference to FIGS. 1 to 4, the structure of the present invention has the following elements:

An easy assembled and detached touch pen 10 with sound emission paths includes the following elements:

A pen body 11 has a hollow portion 12, a touch end 13, a first opening 14, a second opening 15. The hollow portion 12 has an oblong shape and penetrates through a front and a rear side of the pen body 11. The first opening 14 and the second opening 15 are opened at an upper side of the pen body 11 and are communicated to the hollow portion 12. The touch end 13 has a conductive head which is made of steel, conductive rubber, or other conductive medium.

A sound guiding unit 16 is a protrusion having an approximate oblong shape and has a size approximately matched to that of the hollow portion 12 of the pen body 11 so that the sound guiding unit 16 can be embedded into the hollow portion 12. Referring to FIG. 2, at a left end of the upper side of the sound guiding unit 16 has a first upper sound guide hole 17 and a left end of a lateral side of the sound guiding unit 16 has a first lateral sound guide hole 18 which is communicated to the first upper sound guide hole 17. Furthermore, at a right end of the upper side of the sound guiding unit 16 has a second upper sound guide hole 19 and a right end of a lateral side of the sound guiding unit 16 has a second lateral sound guide hole 20 which is communicated to the second upper sound guide hole 19.

Thereby, as illustrated in FIG. 2, the sound guiding unit 16 can be formed with an inserting unit 160 which can be inserted into an insertion hole at a lateral side of the audio device. Preferably, the inserting unit 160 is formed at a side having the first lateral sound guide hole 18. However, the insertion hole of the audio device may be a connection hole of a portable electronic device, which may be a hole for sound emission, power wire insertion, transmission line insertion, or any other hole in the portable electronic device.

In assembly state, the sound guiding unit 16 is embedded into the pen body 11. Then the pen body 11 is installed to an audio device, in that the first lateral sound guide hole 18 and the second lateral sound guide hole 20 are corresponding to the sound output ends of the audio device; and the first upper sound guide hole 17 and the second upper sound guide hole 19 are corresponding to the first opening 14 an the second opening 15 of the pen body 11 so that sound from the audio device is emitted to the first lateral sound guide hole 18 and the second lateral sound guide hole 20 and then are transmitted to the first opening 14 and the second opening 15; and then are transmitted out. The touch pen 10 of the present invention can be taken down easily from the electronic device. Furthermore, since the present invention provides a preferred sound guide path so that sound from the electronic device can be guided out smoothly without any shielding so that a good sound quality is provided.

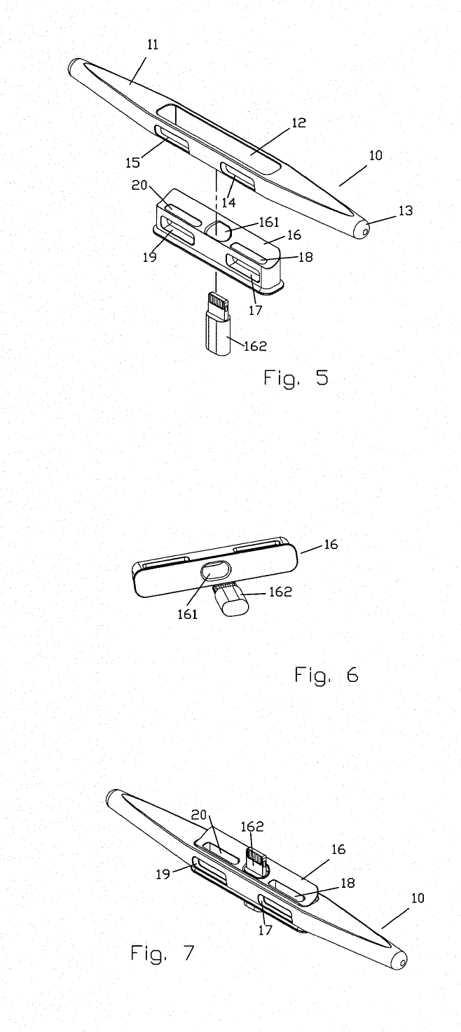

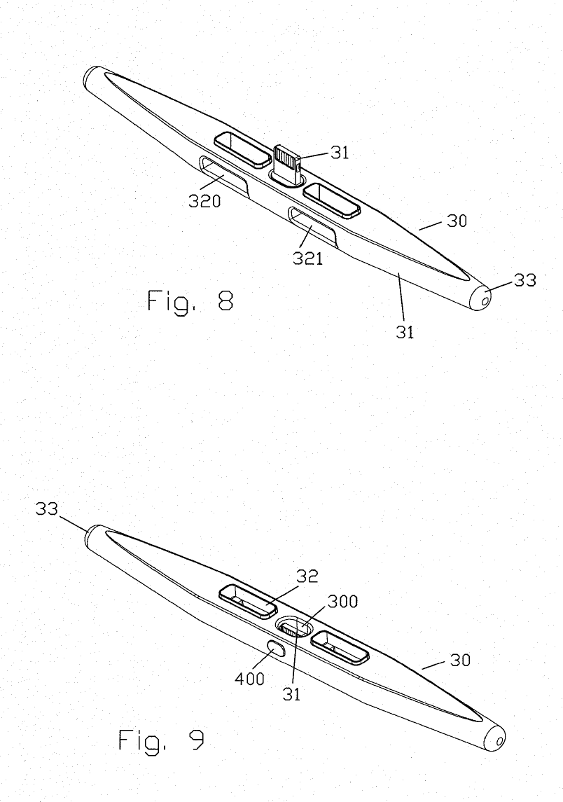

With reference to FIGS. 5 to 7, the second embodiment of the present invention is illustrated. The embodiment is similar to the first embodiment. Thus those elements indicated with numerals which are identical those in the first embodiment have identical functions and structures. Therefore, the details of these elements are not further described herein. Only those different from above the first embodiment are described herein.

In the second embodiment, the inserting unit 162 is detachable from the sound guiding unit 16. Thus the sound guiding unit 16 is formed with a penetrating hole 161 for receiving the inserting unit 162. However, in assembly, the inserting unit 162 may be not used, but to use a power wire (not shown) to pass through the penetrating hole 162 and then to a power hole of an electronic device so as to fix the touch pen 10 of the present invention to the electronic device.

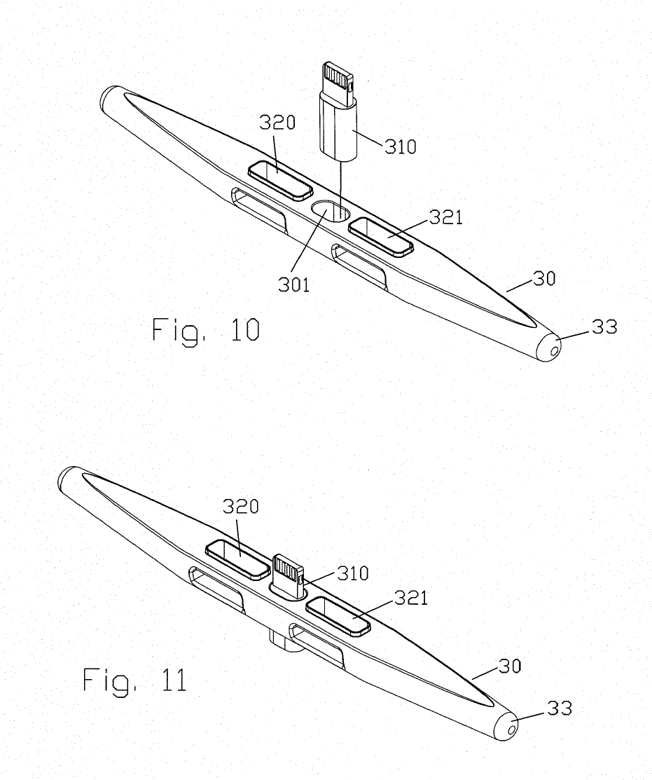

With reference to FIGS. 9 to 10, the third embodiment of the present invention is described herein. The structure of this embodiment will be described herein.

A pen body 30 has two L shape holes 320, 321. Two ends of each L shape hole 320 are opened at two sides of the pen body 30. The two L shape holes are approximately parallel formed in the pen body 30. An insertion hole 300 is formed in the pen body 30 for receiving an inserting unit 31 which is made of non-conductive material. The pen body 30 has a touch end 33. The touch end 33 has a conductive head which is made of steel, conductive rubber, or other conductive medium.

In assembly state, the pen body 11 is installed to an audio device, in that the L shape holes 320, 321 are corresponding to the sound output ends of the audio device; and the two openings of the two L shape holes 320, 321 are corresponding to sound emitting ends (not shown) of the electronic device so that sound from the audio device is emitted out through the two L shape holes 320, 321; and then are transmitted out. The touch pen 10 of the present invention can be taken down easily from the electronic device. Furthermore, since the present invention provides a preferred sound guide path so that sound from the electronic device can be guided out smoothly without any shielding so that a good sound quality is provided.

The embodiment further has an ejecting structure 400 for ejecting the inserting unit 31 to protrude from the insertion hole 300 of the pen body 31 or to reduce into the insertion hole 300.

With reference to FIGS. 9 and 10, another design of the third embodiment of the present invention is illustrated, in that the insertion hole 300 is a penetrating hole and the inserting unit 310 is detachable from the insertion hole. However, in assembly, the inserting unit 310 may be not used, but to use a power wire (not shown) to pass through the penetrating hole 300 and then to a power hole of an electronic device so as to fix the touch pen 30 of the present invention to the electronic device.

The advantages of the present invention are that the present invention provides an easily assembled and detachable touch pen structure which can be attached to the portable device easily and conveniently so that the user need not to carry the pen further. Moreover, the touch pen of the present invention provides a well sound emission path, causing not shielding to the sound emitted from the portable electronic device.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An easy assembled and detached touch pen with sound emission paths comprising:
a pen body having a hollow portion, a touch end, at least one opening; the hollow portion having an oblong shape and penetrating through a front and a rear side of the pen body; the at least one opening being opened at an upper side of the pen body and being communicated to the hollow portion; the touch end having a conductive head;
a sound guiding unit being a protrusion having an approximate oblong shape and having a size approximately matched to that of the hollow portion of the pen body so that the sound guiding unit can be embedded into the hollow portion;
a sound path for guiding sound from one end to another end of the sound guiding unit; in assembly state; the sound path having one end coupled to the sound emitting hole of a portable electronic device; and another end of the sound path being opened so that sound from the electronic device is transmitted out from the sound path; and
an inserting unit formed at the lateral side of the sound guiding unit which can be inserted into an insertion hole at a lateral side of the audio device.

2. The easy assembled and detached touch pen with sound emission paths as claimed in claim 1, wherein
the pen body has two opening, including a first opening and a second opening; the first and second openings being communicated to the hollow portion thereof; and
the sound path of the sound guiding unit is formed that: at a left end of the upper side of the sound guiding unit has a first upper sound guide hole and a left end of a lateral side of the sound guiding unit has a first lateral sound guide hole which is communicated to the first upper sound guide hole; at a right end of the upper side of the sound guiding unit has a second upper sound guide hole and a right end of a lateral side of the sound guiding unit has a second lateral sound guide hole which is communicated to the second upper sound guide hole; and
wherein in assembly state, the sound guiding unit is embedded into the pen body; and then the pen body is installed to an electronic device by inserting into an insertion hole of the electronic device, in that the first lateral sound guide hole and the second lateral sound guide hole are corresponding to the sound output ends of the audio device; and the first upper sound guide hole and the second upper sound guide hole are corresponding to the first opening an the second opening of the pen body so that sound from the audio device is emitted to the first lateral sound guide hole and the second lateral sound guide hole and then are transmitted to the first opening and the second opening; and then are transmitted out.

3. The easy assembled and detached touch pen with sound emission paths as claimed in claim 2, wherein the insertion hole of a portable electronic device is selected from a hole for sound emission, power wire insertion, transmission line insertion, or any other hole in the portable electronic device.

4. The easy assembled and detached touch pen with sound emission paths as claimed in claim 1, wherein the inserting unit is detachable from the sound guiding unit; and the sound guiding unit is formed with a penetrating hole for receiving the inserting unit.

5. An easy assembled and detached touch pen with sound emission paths comprising:
a pen body having two L shape holes; two ends of each L shape hole being opened at two sides of the pen body; the two L shape holes being approximately parallel formed in the pen body; an insertion hole being formed in the pen body; an insertion unit capable of being received within the insertion hole; the insertion unit being made of non-conductive material; the pen body having a touch end; and the touch end having a conductive head;
wherein in assembly state, the inserting unit of the pen body is installed to an audio device, in that the L shape holes are corresponding to the sound output ends of the audio device; and the two openings of the two L shape holes are corresponding to sound emitting ends of the electronic device so that sound from the audio device is emitted out through the two L shape holes; and then are transmitted out.

6. The easy assembled and detached touch pen with sound emission paths as claimed in claim 1, further comprising: an ejecting structure for ejecting the inserting unit to protrude out from the insertion hole of the pen body or to reduce into the insertion hole.

7. The easy assembled and detached touch pen with sound emission paths as claimed in claim 6, wherein the insertion hole is a penetrating hole and the inserting unit is detachable from the insertion hole.
